(19) United States
(12) Patent Application Publication
(10) Pub. No.: US 2013/0136795 A1
(43) Pub. Date: May 30, 2013

(54) SOLID VALSARTAN COMPOSITION

(71) Applicants: Miguel Barrero, Barcelona (ES); Isabel Delgado, Barcelona (ES)

(72) Inventors: Miguel Barrero, Barcelona (ES); Isabel Delgado, Barcelona (ES)

(73) Assignees: Poligono Merck, Barcelona (ES); Generics [UK] Limited, Potters Bar (GB)

(21) Appl. No.: 12/671,269

(22) PCT Filed: Aug. 8, 2008
(86) PCT No.: PCT/GB08/50687

§ 371 Date: Nov. 17, 2010

(30) Foreign Application Priority Data
Aug. 10, 2007 (GB) 0715628.4

(51) Int. Cl. A61J 3/00

(52) U.S. Cl. CPC A61J 3/00
USPC 424/484; 514/381; 514/356; 514/222.5; 264/117

(57) ABSTRACT

The present invention relates to stable solid pharmaceutical compositions comprising valsartan as the active pharmaceutical ingredient. Optionally the compositions comprise one or more further active pharmaceutical ingredients. The invention further relates to methods for preparing said compositions and to the use of said compositions in the treatment or prevention of angiotensin receptor mediated disorders, in particular hypertension and related disorders.

### CROSS-REFERENCE TO RELATED APPLICATION(S)

This application is a Section 371 National Stage application of International No. PCT/GB2008/050687, filed 8 Aug. 2008 and published as WO 2009/022169 A1 on 8 Aug. 2008, which claims priority from the Great Britain Application 0715628.4, filed 10 Aug. 2007, the contents of which are incorporated herein in their entirety for all purposes.

### TECHNICAL FIELD OF THE INVENTION

The present invention relates to stable solid pharmaceutical compositions comprising valsartan as the active pharmaceutical ingredient. Optionally the compositions comprise one or more further active pharmaceutical ingredients. The invention further relates to methods for preparing said compositions and to the use of said compositions in the treatment or prevention of angiotensin receptor mediated disorders, in particular hypertension and related disorders.

### BACKGROUND OF THE INVENTION

Valsartan is a non-peptide, orally active and specific angiotensin II antagonist acting on the AT1 receptor subtype. It is marketed under the trade name Diovan® and is indicated for the treatment of hypertension irrespective of age, sex or race. It is also known to be effective in the treatment of congestive heart failure, angina (whether stable or unstable), myocardial infarction, atherosclerosis, diabetic nephropathy, diabetic cardiac myopathy, renal insufficiency, peripheral vascular disease, left ventricular hypertrophy, cognitive dysfunction, Alzheimer's disease, stroke, headache, and chronic heart failure, and is well tolerated. Combinations with hydrochlorothiazide (HCTZ) and amlodipine are also known for the treatment of hypertension.

Valsartan is chemically described as N-(1-oxopentyl)-N-[[2′-(1H-tetrazol-5-yl)-[1,1′-biphenyl]-4-yl]methyl]-L-valine. Its empirical formula is C24H29N5O3, its molecular weight is 435.5, and its structural formula is:

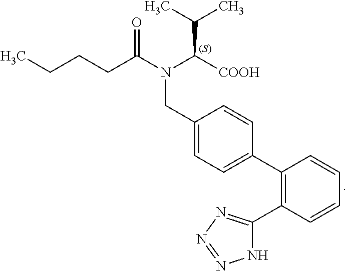

Certain solid pharmaceutical compositions comprising valsartan and processes for their preparation are known.

EP 0 914 119 and EP 1 410 797 disclose solid oral dosage forms and processes for preparing solid oral dosage forms comprising valsartan respectively. The dosage forms comprise valsartan present at not more than 35% by weight based on the total solid oral dosage form. The processes comprise a dry granulation technique involving grinding the active agent (e.g. valsartan) and excipients, subjecting the mixture to a compacting force to form a comprimate, converting the comprimate into a granulate, and compressing the granulate into a solid oral dosage form.

WO 00/38676 describes solid oral dosage forms comprising valsartan (20 to 65%), microcrystalline cellulose (31 to 65%) and crospovidone (2 to 13%). Further, a solid oral dosage form comprising valsartan and microcrystalline cellulose in a weight ratio from 2.5:1 to 0.3:1 is claimed. The method for preparing such dosage forms is again dry granulation, i.e. in the absence of water.

WO 01/97805 claims a composition of valsartan or a pharmaceutically acceptable salt or hydrate thereof and a disintegrant in a weight ratio of between 5.1:1 and 0.5:1. The suggested method for preparing such compositions is again dry granulation, i.e. in the absence of water.

The above disclosures all relate to dry granulation techniques which indicates that the absence of water in the prior art valsartan compositions is important. However, the use of dry granulation is not the preferred method for use in the preparation of compositions comprising valsartan. Firstly, a roller compactor is required and this is not a preferred option as its use can cause high levels of dust. This dust can contain high levels of the active pharmaceutical ingredient, which of course impacts on the safety of plant workers and also on the cost of manufacturing if significant levels of valsartan are being lost in dust. Further, roller compaction tends to be a relatively slow process and thus is not as economic as other known methods for manufacturing pharmaceutical compositions. Furthermore, an increase in temperature caused by this process of compaction could adversely affect drug stability.

WO 06/66961 discloses a valsartan composition prepared by wet granulation wherein the valsartan has a defined particle size. The exemplary embodiments all comprise lactose monohydrate as a diluent or filler. Lactose is a commonly used excipient, but it does suffer from a number of disadvantages. A Maillard-type condensation reaction is likely to occur between lactose and compounds with a primary amine group to form brown coloured products. This reaction occurs more readily with amorphous than crystalline material. The “browning” reaction is base-catalyzed and may therefore be accelerated if alkaline lubricants are used. Lactose is incompatible with amino acids, aminophylline, amphetamines and lisinopril. Valsartan has an L-valine (amino acid) moiety, and thus it is highly likely that incompatibility reactions will occur. Further disadvantages of using lactose are that under conditions of high humidity mould growth may occur and lactose also develops a brown colouration upon storage. Since lactose is often present at a high percentage by weight, the colouration of the tablet may lead to non-compliance by the patient. Further, lactose is known to cause intolerance which occurs in persons with a deficiency in the enzyme lactase. This deficiency results in the lactose being undigested and may cause such clinical symptoms as abdominal cramps, diarrhoea, distension and flatulence. Further still, anhydrous lactose is hygroscopic so that even when valsartan monohydrate is dried, it may absorb water and be converted to the monohydrate again. The monohydrate form of valsartan has a water content of about 5%.

The stability of a pharmaceutical product may be defined as the capability of a particular formulation or composition, in a specific container, to remain within its physical, chemical, microbiological, therapeutic and toxicological specification and to maintain at least about 90% of labelled potency level. Thus, for example, expiration dating is defined as the time in which the pharmaceutical product will remain stable when stored under recommended conditions. This definition of stability includes the maintenance of the dissolution profile of the particular formulation or composition after storage in a closed container system. Indeed, there are strict guidelines issued by the International Conference on Harmonisation (ICH). The ICH Guidelines require that the stability of a drug product be determined under the below conditions:

| | | Minimum time |
|---|---|---|
| | | period covered |
| Study | Storage Condition | by data at submission |
| Long term | 25° C. ± 2° C./60% RH ± 5% RH or | 12 months |
| | 30° C. ± 2° C./65% RH ± 5% RH | |
| Intermediate | 30° C. ± 2° C./65% RH ± 5% RH | 6 months |
| Accelerated | 40° C. ± 2° C./75% RH ± 5% RH | 6 months |

The purpose of storage testing is thus to provide evidence on how the quality of a drug product varies with time under the influence of a variety of environmental factors, such as temperature and humidity, and to establish a shelf life for the drug product and recommended storage conditions. Indeed, in order to obtain approval to place pharmaceutical products on the market, there must be demonstrable consistency in the dissolution profile and consequent bioavailability of different batches of the product.

It has been found by the inventors that under certain conditions compositions of valsartan, including the marketed composition, often fail to show the consistency of dissolution kinetics that is required.

US 2005/0209288 describes compositions comprising (S)-amlodipine and in some embodiments further comprising valsartan. There are also embodiments disclosed that relate to anhydrous compositions. However, the problem these compositions seek to overcome is the degradation of the active ingredients caused by moisture in the formulation. There is no mention of showing that a formulation has consistent dissolution kinetics across the range of storage testing required by regulatory bodies around the world.

Thus, there is a need to provide a solid pharmaceutical composition comprising valsartan which overcomes one or more of current drawbacks. Further, it is desirable to provide a composition that displays consistent dissolution kinetics when tested under accelerated storage conditions required by the ICH Guidelines that are representative of long term storage conditions.

### SUMMARY OF THE INVENTION

The present invention provides a solid pharmaceutical composition comprising granules prepared by wet granulation that overcomes the problems associated with the prior art compositions as highlighted above. A first aspect according to the invention provides a solid pharmaceutical composition comprising a core, wherein said core comprises granules prepared by wet granulation, and wherein said granules comprise valsartan or a pharmaceutically acceptable salt thereof and at least one pharmaceutically acceptable excipient, characterised in that the core has a moisture content of 3% or less. Preferably the moisture content is 2% or less, more preferably 1% or less, or ideally the moisture content is substantially zero.

It has been found by the inventors that a composition having a moisture content of 3% or less is very stable under long term storage conditions or under accelerated storage conditions of 40° C./75% relative humidity. For example, when a composition according to the present invention is stored at 40° C.±2° C. and 75% RH±5% RH for 3 months or even for 4, 5, 6 or more months, the dissolution profile of the composition is substantially unchanged, for example, the dissolution profile is changed by less than 30%, preferably less than 20%, preferably less than 10%, preferably less than 5%.

In a further embodiment, there is provided a composition wherein the granules are present within an extragranular matrix, said matrix comprising one or more pharmaceutically acceptable excipient(s). Preferably the granules are covered or coated with the extragranular matrix and the covered or coated granules are comprised in the core of the pharmaceutical composition. In a preferred embodiment, the extragranular matrix further comprises valsartan or a pharmaceutically acceptable salt thereof.

In further embodiments, a composition according to any aspect of the invention is provided, wherein the excipient(s) is/are selected from the group comprising: binders, fillers, diluents, lubricants and disintegrants. The excipient component(s) may be present in the granule composition and/or the extragranular matrix. The granules or matrix in preferred embodiments are comprised of any combination from the following excipient list: microcrystalline cellulose 102, colloidal anhydrous silica, croscarmellose sodium, magnesium stearate, crospovidone, microcrystalline cellulose 101, and povidone K-30. A particularly preferred embodiment of a granule comprises: valsartan, microcrystalline cellulose 101, crospovidone and povidone K-30. A particularly preferred embodiment of an extragranular matrix comprises: microcrystalline cellulose 102, colloidal anhydrous silica, croscarmellose sodium, magnesium stearate and crospovidone. In a particularly preferred embodiment, the composition comprises less than 10% lactose by weight of the total composition, preferably less than 5%, preferably less than 3%, preferably less than 2%, more preferably less than 1%, and most preferably the composition does not comprise any lactose. As mentioned previously, lactose, generally as lactose monohydrate, is used as a filler, but its use can result in a number of disadvantageous sequalae, for example, browning of the composition or non-suitability of the composition for lactose intolerant individuals.

Preferably the solid pharmaceutical composition according to the invention is suitable for oral administration.

In yet another embodiment according to the invention, the valsartan is present in a unit dose strength of between 1 mg-500 mg, preferably 10 mg-350 mg. Preferably the valsartan is present in a unit dose strength chosen from the group comprising: 20 mg, 40 mg, 60 mg, 80 mg, 120 mg, 160 mg, 240 mg and 320 mg.

In another embodiment, a composition according to the invention is provided wherein the valsartan or the pharmaceutically acceptable salt thereof is present at between about 10-90%, preferably between about 30-70%, and most preferably between about 40-60% by weight of the total composition.

Another embodiment provides a composition according to the invention wherein the composition is coated. The coating of the invention may comprise up to 3% moisture and may be of any type known to the skilled person. In particularly preferred embodiments, the coating is an Opadry® coating.

In one preferred embodiment, a composition according to the invention comprises one or more further active pharmaceutical ingredient(s). Preferably in one preferred embodiment, the one or more further active pharmaceutical ingredient(s) is a compound for the treatment of hypertension. Preferably the one or more active ingredient is a diuretic, which most preferably is hydrochlorothiazide (HCTZ) or a pharmaceutically acceptable salt thereof. In alternative embodiments, the one or more active ingredient is a calcium channel blocker, preferably the calcium channel blocker is amlodipine or a pharmaceutically acceptable salt thereof, most preferably the salt is chosen from the group comprising the besylate, mesylate and maleate salts.

In a second aspect according to the invention there is provided a method for improving the stability of a solid pharmaceutical composition comprising valsartan, said method comprising:

(a) preparing a solid pharmaceutical composition according to the first aspect of the present invention, and
(b) providing means for preventing an increase in the moisture content of the core valsartan composition such that the core moisture content does not exceed about 3%.

Preferably the means is a moisture impermeable vessel, more preferably the vessel is chosen from the group comprising: hermetically sealed foils, plastics, unit dose containers, blister packs, and strip packs, most preferably the vessel is a blister pack, which in a particularly preferred embodiment is an aluminium/aluminium blister pack. Further alternative embodiments may include bottles and vials or other receptacles known in the art to the skilled person. Another embodiment comprises providing a film-coating that is moisture impermeable. The skilled person will realise that the important consideration is that the means is impermeable to moisture and will maintain its integrity over prolonged periods of storage as evidenced by testing under the ICH Guidelines mentioned previously.

In a third aspect according to the invention a kit is provided comprising a solid pharmaceutical composition according to the first aspect of the present invention and means for preventing an increase in the moisture content of the core valsartan composition such that the core moisture content does not exceed about 3%.

It has been found by the inventors that such a kit provides a composition that retains its dissolution kinetics even after accelerated storage testing under conditions of 40° C./75% RH for 3 or 6 months. Preferably the moisture prevention means comprises a moisture impermeable storage vessel. In a preferred embodiment, the vessel is chosen from the group comprising: hermetically sealed foils, plastics, unit dose containers, blister packs, and strip packs, most preferably the vessel is a blister pack, which in a particularly preferred embodiment is an aluminium/aluminium blister pack. Further alternative embodiments may include bottles and vials or other receptacles known in the art to the skilled person.

In a fourth aspect according to the invention there is provided a method of manufacturing a solid pharmaceutical composition according to the first aspect of the present invention, said method comprising:

(a) mixing valsartan or a pharmaceutically acceptable salt thereof together with one or more pharmaceutical excipient(s),
(b) forming granules from the mixture from step (a),
(c) drying the granules from step (b) until at most 3% moisture is retained, and
(d) compressing the granules from step (c) to form a solid dosage form.

In preferred embodiments, the moisture content is 2% or less, more preferably 1% or less, or ideally the moisture content is substantially zero.

In step (b), the granules are preferably formed by wet granulation. In a preferred embodiment, water is used as liquid in the wet granulation process.

In a particularly preferred embodiment, the method comprises the additional step of: preparing an extragranular matrix and adding the dried granules from step (c) to the matrix.

A further embodiment of a method according to the fourth aspect provides one or more further active pharmaceutical ingredient(s) added to the process at step (a). Alternatively the or each further active pharmaceutical ingredient(s) can be added to the extragranular matrix in embodiments comprising said matrix. Preferably in one preferred embodiment, the one or more further active pharmaceutical ingredient(s) is a compound for the treatment of hypertension. Preferably the one or more active ingredient is a diuretic, which most preferably is hydrochlorothiazide (HCTZ) or a pharmaceutically acceptable salt thereof. In alternative embodiments, the one or more active ingredient is a calcium channel blocker, preferably the calcium channel blocker is amlodipine or a pharmaceutically acceptable salt thereof, most preferably the salt is chosen from the group comprising the besylate, mesylate and maleate salts.

A fifth aspect provides a method for improving the stability, during long term or accelerated storage, of a solid pharmaceutical composition comprising a core, wherein said core comprises granules prepared by wet granulation, and wherein said granules comprise valsartan or a pharmaceutically acceptable salt thereof and at least one pharmaceutically acceptable excipient, said method comprising: providing said composition having a moisture content of 3% or less and means for preventing an increase in the moisture content of the composition such that the moisture content does not exceed about 3% during storage, either (i) at 25° C.±2° C. and 60% RH±5% RH for at least 6 months, preferably for at least 12 months, preferably for at least 24 months, more preferably for at least 36 months, or (ii) at 40° C.±2° C. and 75% RH±5% RH for at least 3 months, preferably for at least 6 months, preferably for at least 12 months, more preferably for at least 24 months. In preferred embodiments, the moisture content is 2% or less, more preferably 1% or less, or ideally the moisture content is substantially zero.

Preferably the means is a moisture impermeable vessel, more preferably the vessel is chosen from the group comprising: hermetically sealed foils, plastics, unit dose containers, blister packs, and strip packs, most preferably the vessel is a blister pack, which in a particularly preferred embodiment is an aluminium/aluminium blister pack. Further alternative embodiments may include bottles and vials or other receptacles known in the art to the skilled person. Another embodiment comprises providing a film-coating that is moisture impermeable. The skilled person will realise that the important consideration is that the means is impermeable to moisture and will maintain its integrity over prolonged periods of storage or during accelerated storage conditions. Indeed, the moisture impermeable film-coating may be applied to any aspect or embodiment as required.

A sixth aspect according to the invention provides a method for the treatment or prevention of an angiotensin II receptor mediated condition, comprising providing to a patient in need thereof a composition or a kit according to any of the aspects hereinbefore described. Preferably the condition is selected from the group comprising: hypertension, congestive heart failure, angina (whether stable or unstable), myocardial infarction, atherosclerosis, diabetic nephropathy, diabetic cardiac myopathy, renal insufficiency, peripheral vascular disease, left ventricular hypertrophy, cognitive dysfunction, Alzheimer's disease, stroke, headache, and chronic heart failure; most preferably the condition is hypertension. Preferably the patient is a human.

### DETAILED DESCRIPTION OF THE INVENTION

The terms referring to stability such as “stable composition” or “stable formulation” relate to the dissolution kinetics of the relevant composition or formulation. Thus, a “stable composition” refers to a composition wherein the dissolution profile, i.e. the rate of dissolution, does not significantly decrease when the composition is subjected to accelerated storage testing conditions.

The terms “core”, “core composition”, and “valsartan core composition” are all used interchangeably and as used herein refer to an uncoated composition according to the invention. The core composition may further be coated as provided in certain embodiments.

It is important to distinguish between the types of water present in compositions, as this distinction is an important consideration when defining the different aspects and embodiments of the invention.

“Moisture content” as used herein relates to the amount of unbound water present in the composition. Such water can be present in compositions when a hygroscopic material such as valsartan is left in an atmosphere with water vapour present or as in the present case water can be introduced by a wet granulation technique. The percentage moisture content can be determined by techniques known to the skilled person such as heating the composition and determining the percentage loss-on-drying (LoD).

“Water content” as used herein relates to the total amount of water present in a composition. This includes not only the unbound water or “moisture”, but also the bound water that is part of the crystalline structure of either the valsartan, any one of the excipients that may be present and/or any coating that may be present. This bound water does not contribute to the moisture content limitation according to the invention. Percentage water content can be easily determined by those skilled in the art by the Karl Fischer technique. Further, when calculating the water content of compositions according to the invention, the results may routinely show that the compositions comprise more than 3% water content, however, the moisture content will always be 3% or less with respect to compositions according to the invention.

In one aspect according to the invention there is provided a method for improving the stability of a valsartan composition during long term storage, the method comprising: providing a solid pharmaceutical composition comprising a core, wherein said core comprises granules prepared by wet granulation, and wherein said granules comprise valsartan or a pharmaceutically acceptable salt thereof and at least one pharmaceutically acceptable excipient, characterised in that the core has a moisture content of 3% or less, and means for preventing an increase in the moisture content of the core valsartan composition such that the core moisture content does not exceed about 3%, preferably about 2%, more preferably about 1%, during storage. This prevention may be effected by any of a number of means that are known or that may become apparent to the skilled person. Most preferably, the composition is provided in a moisture impermeable vessel. In certain embodiments this vessel may be selected from the group comprising: hermetically sealed foils, plastics, unit dose containers, blister packs, and strip packs. Most preferably the vessel is a blister pack, preferably an aluminium/aluminium blister pack. It will be apparent to the skilled person that other means of preventing an increase in the moisture content of the core composition are within the scope of the invention. In certain embodiments, the means may comprise a glass vessel such as a glass bottle or indeed a vessel manufactured from any suitable moisture impermeable material. It is also envisaged that in certain embodiments a film-coating will be able to prevent any moisture from being absorbed by the core composition. Such film-coatings are known in the art. The film-coating may also comprise multiple layers, one or more of which are impermeable to moisture which overcomes the problems associated with the prior art compositions as highlighted above. It has been found by the inventors that a core composition having a moisture content of less than 3%, when stored in an environment that does not allow an increase in moisture content, is very stable under long term storage conditions of increased temperature and relative humidity or under accelerated storage conditions of 40° C./75% relative humidity.

Compositions for pharmaceutical use must be subjected to accelerated storage conditions under ICH Guidelines as part of the required storage testing information submitted to Health Authorities in an application for marketing authorisation of a drug product. Accelerated storage testing studies are designed to increase the rate of chemical degradation or physical change of a drug product by using exaggerated storage conditions as part of the formal storage studies. Data from these studies can be used to assess longer term effects at non-accelerated storage conditions and to evaluate the effect of shorter term excursions outside the label storage conditions such as might occur during shipping. During the course of the storage testing the inventors found that certain prior art compositions when subjected to accelerated storage conditions subsequently failed dissolution testing. Indeed, even the marketed product Diovan® showed a dramatic decrease in dissolution after being subjected to accelerated storage conditions.

The inventors also found that film-coatings according to certain embodiments of the invention may also contribute to the moisture content of compositions according to the invention.

The skilled person will of course realise that moisture from the film-coating may move or diffuse from the film-coating to the core composition. Such situations are still within the scope of the invention, provided that even after such movement the core composition still comprises moisture at levels of 3% or less.

US 2005/0209288 described above discloses compositions comprising (S)-amlodipine and in some embodiments further comprising valsartan. There are also embodiments disclosed that relate to anhydrous compositions. The problem these compositions seek to overcome is the degradation of the active ingredients caused by moisture in the formulation. Such degradation can result in impurities contaminating the composition and requiring removal. There is no explicit mention in the disclosure of the effect of moisture and heat on the dissolution kinetics of the disclosed formulations.

In fact the skilled person, when presented with the problem of valsartan formulations that consistently fail dissolution tests under accelerated storage testing conditions of 40° C./75% RH according to ICH Guidelines, would not be encouraged or motivated by any of the prior art to pursue the course that would lead to the invention disclosed and claimed herein.

The compositions according to the invention may further comprise any of the typical excipients useful in preparing solid dosage forms. Such excipients include but are not limited to binders, diluents, lubricants, glidants, stabilizing agents, fillers and surfactants.

One or more of these excipients may be utilised by the skilled person having regard to the particular required properties of the solid dosage form by routine experimentation without undue burden. The amount of each excipient chosen may vary within ranges conventional in the art.

For example, one or more disintegrant(s), such as crospovidone, pregelatinised starch, sodium starch glycolate, microcrystalline cellulose, carboxymethyl cellulose sodium (CMC—Na), cross-linked CMC—Na, polacrilin potassium, low-substituted hydroxypropyl cellulose or mixtures thereof, may be present as part of the granule and/or may be present in the extragranular matrix. Preferably the total amount of disintegrant in the granule and/or the extragranular matrix may range from between about 0-25% by weight of the composition.

The composition according to the invention can also comprise one or more binders, such as polyvinylpyrrolidone (povidone), microcrystalline cellulose, hydroxyethyl cellulose, hydroxypropyl cellulose, hydroxypropyl methyl cellulose or other cellulose ethers, starch, pregelatinised starch, or polymethacrylate, or mixtures thereof, as part of the granule and/or the extragranular matrix. Particularly preferred is povidone K-30. Preferably the total amount of binder in either the granule or the extragranular matrix is between about 0-20%, most preferably between about 0-5% by weight of the composition.

The pharmaceutical compositions according to the invention can further contain diluents. Diluents may include but are not limited to microcrystalline cellulose, powdered cellulose, compressible sugar, fructose, dextrans, other sugars such as mannitol, sorbitol, lactitol, saccharose or a mixture thereof, siliconised microcrystalline cellulose, calcium hydrogen phosphate, calcium carbonate, calcium lactate, or mixtures thereof. A preferred further diluent that also causes reduced sticking properties of tablets to the equipment used for tableting is silica, preferably colloidal or fumed silica. Preferably the excipients include at least one diluent which preferably is microcrystalline cellulose.

The composition according to the invention can also comprise lubricants, such as stearic acid, magnesium stearate, calcium stearate, sodium lauryl sulphate, hydrogenated vegetable oil, hydrogenated castor oil, sodium stearyl fumarate, macrogols, or mixtures thereof. Preferably the lubricant is present in the extragranular matrix. In particularly preferred embodiments, the lubricant is magnesium stearate. In further embodiments, the lubricant is present in an amount of between about 0-5%, most preferably between about 1-3%, particularly about 2% by weight of the total composition.

It is noted that all excipients used in the pharmaceutical compositions or dosage forms made in accordance with the present invention preferably meet or exceed the standards for pharmaceutical ingredients and combinations thereof in the USP/NF. The purpose of the USP/NF is to provide authoritative standards and specifications for materials and substances and their preparations that are used in the practice of the healing arts.

The present pharmaceutical compositions are prepared by common wet granulation techniques known to the skilled person. In preferred embodiments, the valsartan material will be mixed together with one or more appropriate excipient(s) depending on the desired final composition. The excipient(s) may be chosen from those listed above. In certain embodiments, the valsartan and excipient(s) are ground together to result in a mixture with advantageous processing properties, such as flow for example. A process may comprise:

(a) mixing valsartan and the or each excipient,
(b) forming granules from the mixture from step (a),
(c) drying the granules from step (b) until at most 3% moisture is retained, and
(d) compressing the granules from step (c) to form a solid oral dosage form.

In alternative embodiments, an extragranular matrix is prepared comprising one or more of the excipient materials listed above, and the dried granules from step (c) are added to the matrix before the mixture is compressed as per step (d).

Compositions according to the invention may further comprise one or more coatings. Such coatings may comprise conventional materials applied using conventional means in the art. Film-coating formulations usually contain the following components: polymer(s), plasticizer(s), colourant(s)/opacifier(s), and vehicle(s). In film-coating suspensions minor quantities of flavours, surfactants and waxes can be used. The majority of the polymers used in film-coating are either cellulose derivatives, such as cellulose ethers, or acrylic polymers and copolymers. Occasionally encountered are high molecular weight polyethylene glycols, polyvinylpyrrolidone, polyvinyl alcohol and waxy materials. Typical cellulose ethers are hydroxyethyl cellulose, hydroxypropyl cellulose, hydroxypropyl methyl cellulose and methyl cellulose. Acrylic polymers comprise a group of synthetic polymers with diverse functionalities. Some of them can be further modified to enhance swelling and permeability by the incorporation of materials such as water soluble cellulose ethers and starches in order to ensure complete disintegration/dissolution of the film. Coatings may also be employed to control the release of the valsartan from the composition. For example, immediate release or modified release coatings, such as delayed or extended release, are well known to the skilled person and may easily be employed without the need for inventive faculty.

The following paragraphs enumerated consecutively from 1 through 58 provide for various aspects of the present invention. In one embodiment, the present invention provides:

1. A solid pharmaceutical composition comprising a core, wherein said core comprises granules prepared by wet granulation, and wherein said granules comprise valsartan or a pharmaceutically acceptable salt thereof and at least one pharmaceutically acceptable excipient, characterised in that the core has a moisture content of 3% or less.
2. A composition according to paragraph 1, wherein the moisture content is 2% or less.
3. A composition according to paragraph 2, wherein the moisture content is 1% or less.
4. A composition according to paragraph 3, wherein the moisture content is substantially zero.
5. A composition according to any preceding paragraph, wherein the granules are present within an extragranular matrix, said matrix comprising one or more pharmaceutically acceptable excipient(s).
6. A composition according to paragraph 5, wherein the extragranular matrix further comprises valsartan or a pharmaceutically acceptable salt thereof.
7. A composition according to any preceding paragraph, wherein the valsartan or the pharmaceutically acceptable salt thereof is present at between about 10 and 90% by weight of the total composition.
8. A composition according to paragraph 7, wherein the valsartan or the pharmaceutically acceptable salt thereof is present at between about 30 and 70% by weight of the total composition.
9. A composition according to paragraph 8, wherein the valsartan or the pharmaceutically acceptable salt thereof is present at between about 40 and 60% by weight of the total composition.
10. A composition according to any preceding paragraph, wherein the composition is coated.
11. A composition according to any preceding paragraph, wherein the excipient(s) is/are selected from the group comprising: binders, fillers, diluents, lubricants and disintegrants.
12. A composition according to any preceding paragraph, wherein the composition does not contain lactose.
13. A composition according to any preceding paragraph, wherein the valsartan is present in a unit dose strength of between 1 mg-500 mg.
14. A composition according to paragraph 13, wherein the valsartan is present in a unit dose strength chosen from the group comprising: 20 mg, 40 mg, 60 mg, 80 mg, 120 mg, 160 mg, 240 mg and 320 mg.
15. A composition according to any preceding paragraph, comprising one or more further active pharmaceutical ingredient(s).
16. A composition according to paragraph 15, wherein the one or more further active pharmaceutical ingredient(s) is/are a compound for treating hypertension.
17. A composition according to paragraph 15 or 16, wherein the one or more further active pharmaceutical ingredient(s) is/are a diuretic.
18. A composition according to paragraph 17, wherein the diuretic is hydrochlorothiazide (HCTZ) or a pharmaceutically acceptable salt thereof.
19. A composition according to paragraph 15 or 16, wherein the one or more further active pharmaceutical ingredient(s) is/are a calcium channel blocker.
20. A composition according to paragraph 19, wherein the calcium channel blocker is amlodipine or a pharmaceutically acceptable salt thereof.
21. A composition according to paragraph 20, wherein the salt is chosen from the group comprising the besylate, mesylate and maleate salts.
22. A composition according to any preceding paragraph, wherein when the composition is stored at 40° C.±2° C. and 75% RH±5% RH for 3 months, the dissolution profile of the composition is substantially unchanged.
23. A method for improving the stability of a solid pharmaceutical composition comprising valsartan, said method comprising:
(a) preparing a solid pharmaceutical composition according to any of paragraphs 1 to 22, and
(b) providing means for preventing an increase in the moisture content of the core valsartan composition such that the core moisture content does not exceed about 3%.
   24. A method according to paragraph 23, wherein the means is a moisture impermeable vessel.
   25. A method according to paragraph 24, wherein the vessel is chosen from the group comprising: hermetically sealed foils, plastics, unit dose containers, blister packs, and strip packs.
   26. A method according to paragraph 25, wherein the vessel is a blister pack.
   27. A method according to paragraph 26, wherein the blister pack is an aluminium/aluminium blister pack.
   28. A kit comprising a solid pharmaceutical composition according to any of paragraphs 1 to 22 and means for preventing an increase in the moisture content of the core valsartan composition such that the core moisture content does not exceed about 3%.
   29. A kit according to paragraph 28, wherein the means is a moisture impermeable vessel.
   30. A kit according to paragraph 29, wherein the vessel is chosen from the group comprising: hermetically sealed foils, plastics, unit dose containers, blister packs, and strip packs.
   31. A kit according to paragraph 30, wherein the vessel is a blister pack.
   32. A kit according to paragraph 31, wherein the blister pack is an aluminium/aluminium blister pack.
   33. A method of manufacturing a solid pharmaceutical composition according to any of paragraphs 1 to 22, said method comprising:
   (a) mixing valsartan or a pharmaceutically acceptable salt thereof together with one or more pharmaceutical excipient(s),
   (b) forming granules from the mixture from step (a),
   (c) drying the granules from step (b) until at most 3% moisture is retained, and
   (d) compressing the granules from step (c) to form a solid dosage form.
   34. A method according to paragraph 33, wherein the moisture content is 2% or less.
   35. A method according to paragraph 34, wherein the moisture content is 1% or less.
   36. A method according to paragraph 35, wherein the moisture content is substantially zero.
   37. A method according to any of paragraphs 33 to 36, comprising the additional step of: preparing an extragranular matrix and adding the dried granules from step (c) to the matrix.
   38. A method according to paragraph 37, wherein valsartan or a pharmaceutically acceptable salt thereof is added to the extragranular matrix.
   39. A method according to paragraph 37 or 38, wherein one or more further active pharmaceutical ingredient(s) is/are added to the extragranular matrix.
   40. A method according to any of paragraphs 33 to 39, wherein one or more further active pharmaceutical ingredient(s) is/are added to the process at step (a).
   41. A method according to paragraph 39 or 40, wherein the one or more further active pharmaceutical ingredient(s) is/are a compound for treating hypertension.
   42. A method according to any of paragraphs 39 to 41, wherein the one or more further active pharmaceutical ingredient(s) is/are a diuretic.
   43. A method according to paragraph 42, wherein the diuretic is hydrochlorothiazide (HCTZ) or a pharmaceutically acceptable salt thereof.
   44. A method according to any of paragraphs 39 to 41, wherein the one or more further active pharmaceutical ingredient(s) is/are a calcium channel blocker.
   45. A method according to paragraph 44, wherein the calcium channel blocker is amlodipine or a pharmaceutically acceptable salt thereof.
   46. A method according to paragraph 45, wherein the salt is chosen from the group comprising the besylate, mesylate and maleate salts.
   47. A method for improving the stability, during long term or accelerated storage, of a solid pharmaceutical composition comprising a core, wherein said core comprises granules prepared by wet granulation, and wherein said granules comprise valsartan or a pharmaceutically acceptable salt thereof and at least one pharmaceutically acceptable excipient, said method comprising: providing said composition having a moisture content of 3% or less and means for preventing an increase in the moisture content of the composition such that the moisture content does not exceed about 3% during storage, either (i) at 25° C.±2° C. and 60% RH±5% RH for at least 6 months, or (ii) at 40° C.±2° C. and 75% RH±5% RH for at least 3 months.
   48. A method according to paragraph 47, wherein the moisture content is 2% or less.
   49. A method according to paragraph 48, wherein the moisture content is 1% or less.
   50. A method according to paragraph 49, wherein the moisture content is substantially zero.
   51. A method according to any of paragraphs 47 to 50, wherein the means is a moisture impermeable vessel.
   52. A method according to paragraph 51, wherein the vessel is chosen from the group comprising: hermetically sealed foils, plastics, unit dose containers, blister packs, and strip packs.
   53. A method according to paragraph 52, wherein the vessel is a blister pack.
   54. A method according to paragraph 53, wherein the blister pack is an aluminium/aluminium blister pack.
   55. A method for the treatment or prevention of an angiotensin II receptor mediated condition, comprising providing to a patient in need thereof a composition according to any of paragraphs 1 to 22 or a kit according to any of paragraphs 28 to 32.
   56. A method according to paragraph 55, wherein the condition is selected from the group comprising: hypertension, congestive heart failure, angina (whether stable or unstable), myocardial infarction, atherosclerosis, diabetic nephropathy, diabetic cardiac myopathy, renal insufficiency, peripheral vascular disease, left ventricular hypertrophy, cognitive dysfunction, Alzheimer's disease, stroke, headache, and chronic heart failure.
   57. A method according to paragraph 56, wherein the condition is hypertension.
   58. A method according to any of paragraphs 55 to 57, wherein the patient is a human.

Further details of the invention, its objects and advantages are explained hereunder in greater detail in the following non-limiting examples.

### EXAMPLES

### Example 1

160 mg of valsartan, 55 mg of microcrystalline cellulose 101, 50 mg of crospovidone, and 10 mg of povidone K-30 were homogenised in a fluid bed mixer/granulator and granules were formed. The granules were then added to a mixture of 17 mg of microcrystalline cellulose 102, 3 mg of colloidal anhydrous silica, 5 mg of croscarmellose sodium, 5 mg of magnesium stearate and 15 mg of crospovidone. The mixture was compressed into a tablet according to the invention, having formula:

| | | |
|---|---|---|
| Components | mg/tablet | % (w/w) |

Internal phase

| | | |
|---|---|---|
| valsartan | 160 | 50.0 |
| microcrystalline cellulose 101 | 55 | 17.2 |
| crospovidone | 50 | 15.6 |
| povidone K-30 | 10 | 3.1 |

External Phase

| | | |
|---|---|---|
| microcrystalline cellulose 102 | 17 | 5.3 |
| colloidal anhydrous silica | 3 | 0.9 |
| croscarmellose sodium | 5 | 1.6 |
| magnesium stearate | 5 | 1.6 |
| crospovidone | 15 | 4.7 |

Tablets comprising 80 mg and 40 mg of valsartan were also made by the above process with the excipients being scaled accordingly.

### Comparative Examples

Tables 1-4 below show the results of dissolution testing on various compositions. The compositions tested by the inventors comprised valsartan from different sources and even different batches from the same source. The compositions comprise valsartan from different sources and batches, indicating that dissolution failure after 3 months of accelerated storage testing is not due to a poor source or an erroneous batch, but is a phenomenon seen consistently during accelerated storage conditions. Furthermore, the excipients were also varied when trying to determine the cause of the dissolution failure at accelerated storage testing conditions.

TABLE 1
showing results of dissolution testing of valsartan from source 1-160 mg
film-coated tablets packaged in PVC-PVdC/Alu blister packs stored at
40° C./75% RH. The core composition of the tablets was as listed in
example 1.

| | Initial | 3 months | 6 months |
|---|---|---|---|
| % Moisture content (determined by LoD) | 3.01 | 5.21 | 5.31 |
| % Increase in moisture | 0 | 2.20 | 2.30 |
| Time intervals (min) | % dissolution | | |
| 5 | 84 | 1 | 1 |
| 10 | 95 | 4 | 3 |
| 15 | 97 | 5 | 4 |
| 20 | 97 | 7 | 5 |
| 30 | 97 | 10 | 8 |

TABLE 2
showing results of dissolution testing of a second batch of valsartan
from the same source as that in Table 1-160 mg film-coated tablets
packaged in PVC-PVdC/Alu blister packs stored at 40° C./75% RH.
The core composition was altered such that there was an increase in
the amount of crospovidone.

| | Initial | 1 month | 3 months | 6 months |
|---|---|---|---|---|
| % Moisture content | 3.72 | 4.12 | 5.72 | 5.52 |
| (determined by LoD) | | | | |
| % Increase in moisture | 0 | 0.40 | 2.00 | 1.80 |
| Time intervals (min) | % dissolution | | | |
| 5 | 91 | 78 | 19 | 1 |
| 10 | 97 | 93 | 40 | 2 |
| 15 | 98 | 96 | 55 | 4 |
| 20 | 98 | 97 | 66 | 5 |
| 30 | 98 | 97 | 80 | 7 |

TABLE 3
showing results of dissolution testing of valsartan from source 2-160 mg
coated core tablets packaged in PVC-PVdC/Alu blister packs stored at
40° C./75% RH. The core composition of the tablets was as listed in
example 1.

| | Initial | 3 months | 6 months |
|---|---|---|---|
| % Moisture content (determined by LoD) | 3.62 | 5.02 | 5.52 |
| % Increase in moisture | 0 | 1.40 | 1.90 |
| Time intervals (min) | % dissolution | | |
| 5 | 86 | 1 | 1 |
| 10 | 96 | 4 | 3 |
| 15 | 98 | 6 | 4 |
| 20 | 98 | 7 | 5 |
| 30 | 98 | 10 | 7 |

TABLE 4
showing results of dissolution testing of valsartan from source 3-160 mg
uncoated core tablets comprising micronised valsartan, packaged in PVC-
PVdC/Alu blister packs stored at 40° C./75% RH. The core composition
was altered such that the ratio of cellulose and crospovidone in the
external phase was increased.

| | Initial | 1 month | 3 months | 6 months |
|---|---|---|---|---|
| % Moisture content | | | | |
| (determined by LoD) | | | | |
| % Increase in moisture | 0 | 1.4 | 4.5 | 3.9 |
| Time intervals (min) | % dissolution | | | |
| 5 | 32 | 46 | 20 | 3 |
| 10 | 55 | 72 | 43 | 8 |
| 15 | 69 | 84 | 61 | 12 |
| 20 | 78 | 92 | 74 | 15 |
| 30 | 88 | 98 | 88 | 22 |

### Example 2

Tables 5-8 below show the results of dissolution testing of compositions according to the invention. The results show that when a core composition according to the invention, i.e. comprising a core as detailed in example 1 and comprising less than 3% moisture, is stored in packaging that does not allow absorption of moisture by the composition, dissolution is not significantly affected by storage under the conditions specified.

TABLE 5
showing results of dissolution testing of 160 mg film-coated tablets
packaged in Alu/Alu blister packs stored at 40° C./75% RH. The
composition of the tablets was as listed in example 1.

| | Initial | 1 month | 3 months |
|---|---|---|---|
| % Moisture content | 0.29 | 0 | 0 |
| (determined by LoD) | | | |
| % Increase in moisture | 0 | 0 | 0 |
| Time intervals (min) | % dissolution | | |
| 5 | 87 | 92 | 91 |
| 10 | 95 | 97 | 97 |
| 15 | 97 | 99 | 99 |
| 20 | 98 | 100 | 100 |
| 30 | 98 | 100 | 100 |

TABLE 6
showing results of dissolution testing of a second batch of 160 mg film-
coated tablets packaged in Alu/Alu blister packs stored at 40° C./75% RH.
The composition of the tablets was as listed in example 1.

| | Initial | 1 month | 3 months |
|---|---|---|---|
| % Moisture content (determined by LoD) | 0.64 | 0 | 0 |
| % Increase in moisture | 0 | 0 | 0 |
| Time intervals (min) | % dissolution | | |
| 5 | 95 | 98 | 96 |
| 10 | 99 | 101 | 99 |
| 15 | 99 | 101 | 99 |
| 20 | 99 | 101 | 99 |
| 30 | 99 | 101 | 99 |

TABLE 7
showing results of dissolution testing of 80 mg film-coated tablets packaged
in Alu/Alu blister packs stored at 40° C./75% RH. The composition of the
tablets was as listed in example 1.

| | Initial | 1 month | 3 months |
|---|---|---|---|
| % Moisture content (determined by LoD) | 1.35 | 0.45 | 0.85 |
| % Increase in moisture | 0 | 0 | 0 |
| Time intervals (min) | % dissolution | | |
| 5 | 91 | 92 | 90 |
| 10 | 97 | 98 | 97 |
| 15 | 99 | 99 | 99 |
| 20 | 100 | 100 | 99 |
| 30 | 100 | 100 | 100 |

TABLE 8
showing results of dissolution testing of 40 mg film-coated tablets packaged
in Alu/Alu blister packs stored at 40° C./75% RH. The composition of the
tablets was as listed in example 1.

| | Initial | 1 month | 3 months |
|---|---|---|---|
| % Moisture content (determined by LoD) | 0.29 | 0 | 0 |
| % Increase in moisture | 0 | 0 | 0 |
| Time intervals (min) | % dissolution | | |
| 5 | 97 | 99 | 97 |
| 10 | 99 | 100 | 99 |
| 15 | 100 | 101 | 99 |
| 20 | 100 | 101 | 100 |
| 30 | 100 | 101 | 100 |

The dissolution tests were standard paddle tests known to the skilled person carried out in a phosphate buffer of pH 6.8 with paddle speed rotating at 50 rpm.

Thus it can be deduced that after accelerated storage testing, which as explained above is indicative of prolonged storage and is required by Regulatory Authorities around the world, the products according to the prior art did not dissolve adequately and consequently may not satisfy the regulatory requirements of the Health Authorities. It can also be seen that the product according to the invention, having components as detailed in example 1, is not affected by the accelerated storage testing conditions. Consequently, the composition according to the invention would pass the accelerated storage testing requirements, satisfy the regulatory requirements of the Health Authorities, and would not need to be discarded which is both practically and economically advantageous.

1-73. (canceled)

74. A solid pharmaceutical composition comprising a core, wherein said core comprises granules prepared by wet granulation, and wherein said granules comprise valsartan or a pharmaceutically acceptable salt thereof and at least one pharmaceutically acceptable excipient, characterised in that the core has a moisture content of 3% or less.

75. A composition according to claim 74, wherein:
(i) the moisture content is 2% or less; and/or
(ii) the moisture content is 1% or less; and/or
(iii) the moisture content is substantially zero; and/or
(iv) the granules are present within an extragranular matrix, said matrix comprising one or more pharmaceutically acceptable excipient(s); and/or
(v) the granules are present within an extragranular matrix, said matrix comprising one or more pharmaceutically acceptable excipient(s) and valsartan or a pharmaceutically acceptable salt thereof; and/or
(vi) the valsartan or the pharmaceutically acceptable salt thereof is present at between about 10 and 90% by weight of the total composition; and/or
(vii) the valsartan or the pharmaceutically acceptable salt thereof is present at between about 30 and 70% by weight of the total composition; and/or
(viii) the valsartan or the pharmaceutically acceptable salt thereof is present at between about 40 and 60% by weight of the total composition; and/or
(ix) the composition is coated; and/or
(x) the excipient(s) is/are selected from the group comprising: binders, fillers, diluents, lubricants and disintegrants; and/or
(xi) the composition does not contain lactose; and/or
(xii) the valsartan is present in a unit dose strength of between 1 mg-500 mg; and/or
(xiii) the valsartan is present in a unit dose strength chosen from the group comprising: 20 mg, 40 mg, 60 mg, 80 mg, 120 mg, 160 mg, 240 mg and 320 mg; and/or
(xiv) when the composition is stored at 40° C.±2° C. and 75% RH±5% RH for 3 months, the dissolution profile of the composition is substantially unchanged.

76. A composition according to claim 74:
(i) comprising one or more further active pharmaceutical ingredient(s); and/or
(ii) comprising one or more further active pharmaceutical ingredient(s) for treating hypertension; and/or
(iii) further comprising one or more diuretic(s); and/or
(iv) further comprising hydrochlorothiazide (HCTZ) or a pharmaceutically acceptable salt thereof; and/or
(v) further comprising one or more calcium channel blocker(s); and/or
(vi) further comprising amlodipine or a pharmaceutically acceptable salt thereof; and/or
(vii) further comprising amlodipine besylate, mesylate or maleate salt.

77. A method for improving the stability of a solid pharmaceutical composition comprising valsartan, said method comprising:
(a) preparing a solid pharmaceutical composition according to claim 74, and
(b) providing means for preventing an increase in the moisture content of the core valsartan composition such that the core moisture content does not exceed about 3%.

78. A method according to claim 77, wherein:
(i) the means is a moisture impermeable vessel; and/or
(ii) the means is a moisture impermeable vessel chosen from the group comprising: hermetically sealed foils, plastics, unit dose containers, blister packs, and strip packs; and/or
(iii) the means is a blister pack; and/or
(iv) the means is an aluminium/aluminium blister pack.

79. A kit comprising a solid pharmaceutical composition according to claim 74 and means for preventing an increase in the moisture content of the core valsartan composition such that the core moisture content does not exceed about 3%.

80. A kit according to claim 79, wherein:
(i) the means is a moisture impermeable vessel; and/or
(ii) the means is a moisture impermeable vessel chosen from the group comprising: hermetically sealed foils, plastics, unit dose containers, blister packs, and strip packs; and/or
(iii) the means is a blister pack; and/or
(iv) the means is an aluminium/aluminium blister pack.

81. A method of manufacturing a solid pharmaceutical composition according to claim 74, said method comprising:
(a) mixing valsartan or a pharmaceutically acceptable salt thereof together with one or more pharmaceutical excipient(s),
(b) forming granules from the mixture from step (a),
(c) drying the granules from step (b) until at most 3% moisture is retained, and
(d) compressing the granules from step (c) to form a solid dosage form.

82. A method according to claim 81, wherein:
(i) the moisture content is 2% or less; and/or
(ii) the moisture content is 1% or less; and/or
(iii) the moisture content is substantially zero; and/or
(iv) the method comprises the additional step of: preparing an extragranular matrix and adding the dried granules from step (c) to the extragranular matrix; and/or
(v) the method comprises the additional step of: preparing an extragranular matrix and adding the dried granules from step (c) and valsartan or a pharmaceutically acceptable salt thereof to the extragranular matrix; and/or
(vi) the method comprises the additional step of: preparing an extragranular matrix and adding the dried granules from step (c) and one or more further active pharmaceutical ingredient(s) to the extragranular matrix; and/or
(vii) the method comprises the additional step of: preparing an extragranular matrix and adding the dried granules from step (c), valsartan or a pharmaceutically acceptable salt thereof and one or more further active pharmaceutical ingredient(s) to the extragranular matrix; and/or
(viii) one or more further active pharmaceutical ingredient(s) is/are added to the process at step (a).

83. A method according to claim 82, wherein the one or more further active pharmaceutical ingredient(s) is/are:
(i) a compound for treating hypertension; and/or
(ii) a diuretic; and/or
(iii) hydrochlorothiazide (HCTZ) or a pharmaceutically acceptable salt thereof; and/or
(iv) a calcium channel blocker; and/or
(v) amlodipine or a pharmaceutically acceptable salt thereof; and/or
(vi) amlodipine besylate, mesylate and maleate salt.

84. A method for improving the stability, during long term or accelerated storage, of a solid pharmaceutical composition comprising a core, wherein said core comprises granules prepared by wet granulation, and wherein said granules comprise valsartan or a pharmaceutically acceptable salt thereof and at least one pharmaceutically acceptable excipient, said method comprising: providing said composition having a moisture content of 3% or less and means for preventing an increase in the moisture content of the composition such that the moisture content does not exceed about 3% during storage, either (i) at 25° C.±2° C. and 60% RH±5% RH for at least 6 months, or (ii) at 40° C.±2° C. and 75% RH±5% RH for at least 3 months.

85. A method according to claim 84, wherein:
(i) the moisture content is 2% or less; and/or
(ii) the moisture content is 1% or less; and/or
(iii) the moisture content is substantially zero; and/or
(iv) the means is a moisture impermeable vessel; and/or
(v) the means is a moisture impermeable vessel chosen from the group comprising: hermetically sealed foils, plastics, unit dose containers, blister packs, and strip packs; and/or
(vi) the means is a blister pack; and/or
(vii) the means is an aluminium/aluminium blister pack.

86. A method for the treatment or prevention of an angiotensin II receptor mediated condition, comprising providing to a patient in need thereof a composition according to claim 74.

87. A method according to claim 13, wherein the condition is selected from the group comprising: hypertension, congestive heart failure, angina (whether stable or unstable), myocardial infarction, atherosclerosis, diabetic nephropathy, diabetic cardiac myopathy, renal insufficiency, peripheral vascular disease, left ventricular hypertrophy, cognitive dysfunction, Alzheimer's disease, stroke, headache, and chronic heart failure.

88. A method according to claim 86, wherein the condition is hypertension.

89. A method according to claim 86, wherein the patient is a human.

90. A method for the treatment or prevention of an angiotensin II receptor mediated condition, comprising providing to a patient in need thereof a kit according to claim 79.

91. A method according to claim 17, wherein the condition is selected from the group comprising: hypertension, congestive heart failure, angina (whether stable or unstable), myocardial infarction, atherosclerosis, diabetic nephropathy, diabetic cardiac myopathy, renal insufficiency, peripheral vascular disease, left ventricular hypertrophy, cognitive dysfunction, Alzheimer's disease, stroke, headache, and chronic heart failure.

92. A method according to claim 90, wherein the condition is hypertension.

93. A method according to claim 90, wherein the patient is a human.
